(19) United States
(12) Patent Application Publication
(10) Pub. No.: US 2026/0212213 A1
(43) Pub. Date: Jul. 23, 2026

(54) CUSTOMIZED CLOUD-BASED ASSISTANTS AND ANALYTICS

(71) Applicant: QlikTech International AB, Lund (SE)

(72) Inventors: Nicholas R. Magnuson, Park City, UT (US); Henrik Svenell, Malmo (SE); Steven Pressland, Borough Green (GB)

(21) Appl. No.: 19/455,093

(22) Filed: Jan. 21, 2026

Related U.S. Application Data
(60) Provisional application No. 63/747,505, filed on Jan. 21, 2025.

(51) Int. Cl. G06N 5/01

(52) U.S. Cl. CPC G06N 5/01

(57) ABSTRACT

Described herein are methods and systems for cloud-based assistants and analytics. These methods and systems may support customized cloud-based assistants that may access knowledge bases and applications. In some aspects, the assistants may perform actions based on user queries. The system may provide natural language interaction capabilities and data visualization tools. In some cases, the assistants may integrate with existing analytics platforms to enhance data exploration and insight generation. The methods may include processing structured and unstructured data sources to create searchable knowledge bases. The system may utilize large language models and vector databases to enable contextual understanding of user queries and generate relevant responses. Additionally, the methods may support automated actions triggered by insights derived from user interactions.

### CROSS-REFERENCE TO RELATED PATENT APPLICATION

This application claims priority to U.S. Prov. App. No. 63/747,505, filed on Jan. 21, 2025, the entirety of which is incorporated by reference herein.

### BACKGROUND

Cloud-based analytics platforms have become increasingly important for organizations seeking to utilize data for decision-making. These platforms offer powerful tools for data analysis, visualization, and collaboration. However, many existing solutions struggle to effectively combine structured and unstructured data analysis within a single system. Additionally, the complexity of these platforms often requires specialized knowledge, limiting their accessibility to non-technical users. There is a growing need for intuitive, AI-powered analytics solutions that can seamlessly integrate diverse data sources, provide natural language interfaces, and offer customizable assistance tailored to specific business needs. As organizations continue to generate vast amounts of data, the ability to quickly extract meaningful insights and automate actions based on those insights becomes crucial for maintaining a competitive edge.

### SUMMARY

It is to be understood that both the following general description and the following detailed description are exemplary and explanatory only and are not restrictive. Described herein are methods and systems for cloud-based assistants and analytics. These methods and systems may support customized cloud-based assistants that may access knowledge bases and applications. In some aspects, the assistants may perform actions based on user queries. The system may provide natural language interaction capabilities and data visualization tools. In some cases, the assistants may integrate with existing analytics platforms to enhance data exploration and insight generation. The methods may include processing structured and unstructured data sources to create searchable knowledge bases. The system may utilize large language models and vector databases to enable contextual understanding of user queries and generate relevant responses. Additionally, the methods may support automated actions triggered by insights derived from user interactions.

The methods and systems described herein may utilize an associative engine for querying structured data, which may offer several advantages over traditional SQL-based approaches. For example, the associative engine may provide faster and more efficient data processing compared to SQL-based methods. The associative engine may maintain the selection state of prior queries, allowing it to build upon previous results without needing to rerun entire queries. This approach may be particularly beneficial in scenarios involving chain-of-thought reasoning or recursive questioning. Further, unlike SQL-based systems that often rely on predefined joins, the associative engine may treat all data relationships as full outer joins at runtime. This approach may allow for more comprehensive data exploration and may reveal unexpected insights. Additionally, the associative engine may provide the ability to answer not only the specific question asked but also related questions that were not explicitly stated. This may allow the system to show data that does not match the query criteria, potentially revealing valuable insights that might otherwise be overlooked.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1A shows an example system, according to aspects of the present disclosure.

FIG. 1B shows an example system, according to aspects of the present disclosure.

FIG. 2 shows an example user interface, according to aspects of the present disclosure.

FIG. 3 shows an example system architecture, according to aspects of the present disclosure;

FIG. 4 shows an example user interface of an analytics platform, according to aspects of the present disclosure;

FIG. 5A shows a first example user interface of the analytics platform, according to aspects of the present disclosure;

FIG. 5B shows a second example user interface of the analytics platform, according to aspects of the present disclosure;

FIG. 5C shows a third example user interface of the analytics platform, according to aspects of the present disclosure;

FIG. 5D shows a fourth example user interface of the analytics platform, according to aspects of the present disclosure;

FIG. 5E shows a fifth example user interface of the analytics platform, according to aspects of the present disclosure;

FIG. 5F shows a sixth example user interface of the analytics platform, according to aspects of the present disclosure;

FIG. 5G shows an example automated action of the analytics platform, according to aspects of the present disclosure; and

FIG. 6 shows an example system, according to aspects of the present disclosure.

FIG. 7 shows a flowchart for an example method, according to aspects of the present disclosure.

FIG. 8 shows a flowchart for an example method, according to aspects of the present disclosure.

FIG. 9 shows a flowchart for an example method, according to aspects of the present disclosure.

### DETAILED DESCRIPTION

This summary is not intended to identify critical or essential features of the disclosure, but merely to summarize certain features and variations thereof. Other details and features will be described in the sections that follow.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint. “Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

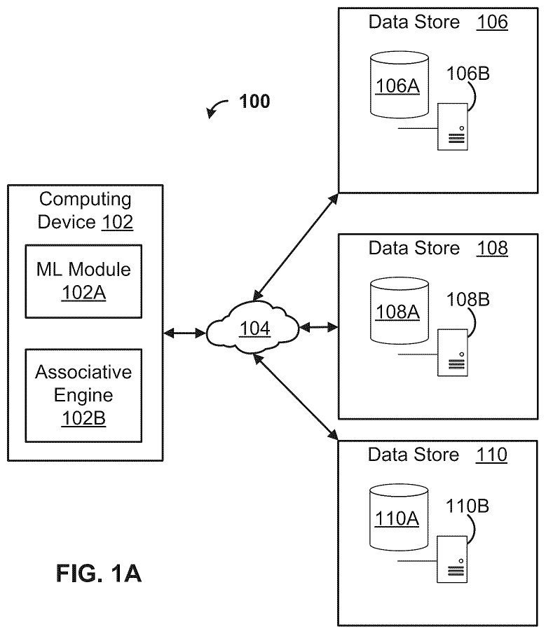

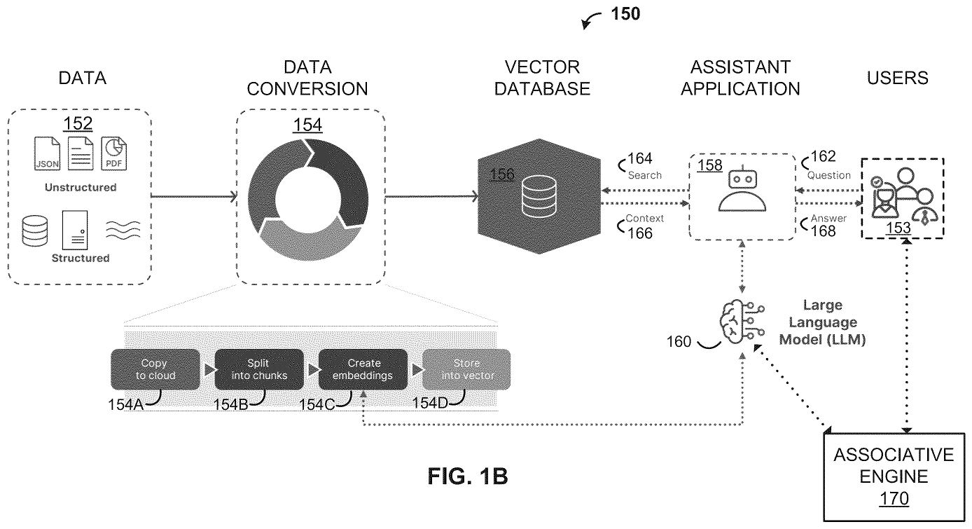

Turning now to FIG. 1A, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1A as being resident at the computing device 102, it is to be understood that the ML module 102A may be resident at one or more computing devices that may be local or remote to the computing device 102. The computing device 102 may comprise an Associative Engine (AE) module 102B. The AE module 102B may store one or more data models in-memory (e.g., within the primary memory/RAM of the computing device 102) and manage associations between data elements. For example, based on data elements within a data model, the AE module 102B may provide near-instantaneous calculation of aggregates, selections, and filters as further described herein.

Each of the plurality of data stores 106, 108, 110 may comprise one or more data storage mechanisms, such as a relational database, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some cases, the system 100 may be integrated with other systems or technologies to enhance its functionality. For example, the system 100 may be integrated with a business intelligence platform, a data warehouse, a customer relationship management system, or other types of systems. This integration may allow the system 100 to access additional data, provide more comprehensive insights, or offer additional features to the users.

As an example, turning now to FIG. 1B, an example system 150 is shown. The system 150 may comprise one or more components of the system 100, as further described herein. That is, the capabilities of the system 150 as described herein also apply to the system 100, as the two systems may share—or may each comprise—each described component, resource, device, etc., that performs each of the actions described herein (and potentially not shown).

In some aspects, the system 150 may be utilized to transform data 152 into a format that may be consumed by one or more Large Language Models (LLMs). For example, the data 152 may comprise both structured data and unstructured data. The structured data may be related to one or more analytics “apps” as further described herein, which may include one or more data models, data tables, information regarding connections to various sources such as databases, spreadsheets, and/or web services in an analytics system, etc. The unstructured data may comprise file-based sources, such as presentations, mail archives, text documents, PDFs, transcripts, etc.

The data 152 may be split into manageable chunks in a data conversion process 154. At step 154A, the data 152 may be copied to a cloud-based environment. At step 154B, the data 152 may be split into chunks (e.g., portions of text data). The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 154C. This conversion may be performed by an LLM or another type of machine learning model. Different types of LLMs may be used depending on the specific requirements of the task. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For ease of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 154C, each chunk may be converted into an embedding via LLM 160 in FIG. 1B (e.g., resident at and/or within the control of the ML module 102A). Though FIG. 1B only shows one LLM 160, it is to be understood that the system 150 may comprise multiple LLMs 160, such as a primary LLM and a secondary LLM as further described herein. Each embedding may comprise a numerical representation of the corresponding chunk of the data 152 that may be consumed/used by an LLM(s) (e.g., by the LLM 160). At step 154D, the embeddings may be stored in a vector database 156 (e.g., resident at and/or controlled by any of the data stores 106, 108, 110). Additionally, the vector database 156 may store embeddings related to unstructured data, such as presentations, mail archives, text documents, PDFs, transcripts, etc.

The vector database 156 may semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 156 may employ techniques such as dimensionality reduction to optimize the storage and retrieval of embeddings without losing the semantic relationships within the data.

After embeddings are generated and semantically indexed in the vector database 156, an assistant application 158 (e.g., resident at and/or controlled by any of the servers 106B, 108B, 110B), such as a natural language (“NL”) assistant and/or a chatbot, may provide answers to queries related to the data 152. For example, such answers may comprise a NL response(s) and/or one or more visualizations as further described herein. The assistant application 158 may interact with the LLM 160 to process natural language queries from one or more users 153. The one or more users 153 may interact with the assistant application 158 via a client device, such as the computing device 102, a mobile device, or a web browser. The assistant application 158 may be designed to provide responses in various formats. In some cases, the assistant application 158 may provide text-based responses. In other cases, the assistant application 158 may provide visual or auditory responses. For example, the assistant application 158 may generate a graphical representation of the response, or it may generate an audio file that verbally communicates the response, a combination thereof, and/or the like.

As shown in FIG. 1B, the one or more users 153 may send a question 162 The question 162 may comprise a NL query, an image, a recording, a combination thereof, and/or the like. The question 162 may be sent to the assistant application 158. The assistant application 158 may perform a search 164 against the vector database 156 in order to receive context 166. The context 166 may be based on the embeddings stored in the vector database 156 (e.g., the data 152), and the context 166 may be used by the assistant application 158 to provide an answer 168 (e.g., a NL answer/output). In this way, the “knowledge” used by the system 150 to provide answers 168 to questions 162 may be based on the data 152, which may form all or part of the basis for the context 166 provided to the assistant application 158. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

The data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150's process, so details on user roles and their associated permissions may be included. To ensure the vector database 156 remains current and accurate, the system 150 may periodically capture static data extracts or snapshots of the data used in the app. For example, a purpose-built API(s) may be used by the system 150 to programmatically extract the necessary data and metadata, ensuring that all relevant transformations and calculations are captured. The extracted data may then be organized into a structured format suitable for the vector database 156 by the system 150. Including all relevant metadata provides context and enhances the usability of the vector database 156.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create—and maintain—robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user's 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

Additionally, the context 166 may comprise contextual metadata. As shown in FIG. 1B, the system 150 may further comprise an associative engine 170. The associative engine 170 may correspond to the AE module 102B of the computing device 102 (e.g., the client device(s) associated with the user(s) 153). When a user 153 sends a question 162, (e.g., seeks an insight(s) by asking a natural language question and/or by interacting with a visual analytic interface by selecting a chart or a portion of a chart for explanation), the associative engine 170 gathers contextual metadata about the user's 153 current analytical context. This contextual metadata can include, but is not limited to: data hypercubes or subsets relevant to the question 162 (e.g., dimensions, measures, and/or their values), a current selection state (e.g., filters applied, like specific regions, products, or time periods selected), a data model schema and/or relationships (e.g. how fields and tables are connected), the user's 153 selection or query history (e.g., what the user 153 looked at or asked just before, to maintain context in a conversational thread), and/or any annotations or rules defined in a corresponding analytics-system app (e.g., labels like “High-value customer” or custom calculations defined by the user 153).

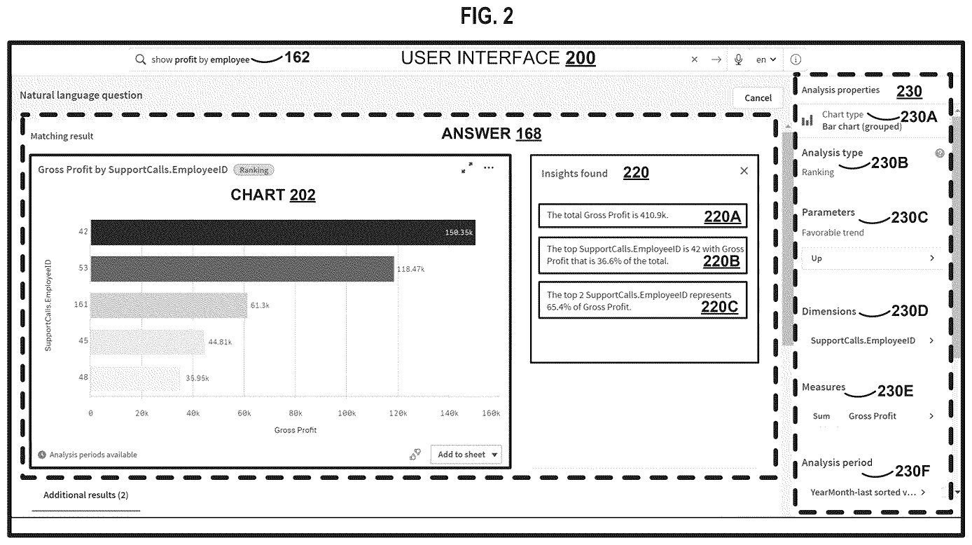

Turning now to FIG. 2, an example user interface 200 is shown. The user interface 200 may provide an interactive environment for users to engage with the natural language processing and insight generation capabilities of the systems described herein. The user interface 200 may be displayed on a computing device, such as the computing device 102 shown in FIG. 1A (e.g., accessed through a web browser or application running on a client device).

The user interface 200 may include a question 162 input field. The question input field 162 may allow users to enter natural language queries or requests for insights about specific data or visualizations. The question 162 shown in the user interface 200 may correspond to the question 162 described in FIG. 1B. Users may enter natural language queries into this field to request insights about their data. The question 162 may be processed by the assistant application 158 as described in relation to FIG. 1B. The input field may support various types of queries, ranging from simple data requests to complex analytical questions. Users may ask questions such as “What were the top products last quarter?” or “Show me sales trends by region.” The system may interpret these natural language inputs and convert them into appropriate data operations.

The user interface 200 may also display an answer 168 in response to the user's question 162. The answer 168 shown in the user interface 200 may correspond to the answer 168 generated by the system 150 as described in FIG. 1B. The answer 168 may comprise natural language text that provides insights, explanations, and interpretations of the data. The answer 168 may be generated using the large language model(s) 160 and may incorporate contextual metadata from the associative engine 170. The natural language response may be tailored to the user's specific query and may include relevant details, comparisons, and observations about the data. The answer 168 may comprise natural language text that provides insights, explanations, or responses to the user's query.

A chart 202 may be displayed within the user interface 200. The chart 202 may provide a visual representation of data relevant to the user's query or the current analytical context. The chart 202 may be generated based on data retrieved from the associative engine 170 and/or from the vector database 156. The chart 202 may be interactive, allowing users to click on specific elements to request additional insights or explanations. The visualization may be automatically selected based on the type of analysis being performed and the nature of the data being displayed. The chart 202 may be a visual representation of data relevant to the user's query or the current context of analysis.

The user interface 200 may generate and display a plurality of insights 220. These insights may be automatically generated based on the current data context and may provide users with additional analytical observations beyond their specific query. The plurality of insights 220 may include a first insight 220A, a second insight 220B, and a third insight 220C. Each insight may represent a different analytical finding or observation about the data. These insights may be generated using the template-based approaches described herein, combined with the natural language generation capabilities of the large language models. The insights may be generated by the system 150 based on the data represented in the chart 202, the user's query, and other contextual information. Each of these insights may provide different perspectives or analyses of the data.

The system may also provide analysis properties 230 that support the generated insights. The analysis properties 230 may include detailed analytical information that forms the foundation for the insights presented to the user. These properties may include a first analysis property 230A, a second analysis property 230B, a third analysis property 230C, a fourth analysis property 230D, a fifth analysis property 230E, and a sixth analysis property 230F. Each analysis property may contain specific data points, measurements, calculations, or metadata that contribute to the overall insight generation process. The analysis properties 230 may be derived from the contextual metadata provided by the associative engine 170 and may include information such as current selection states, hypercube data, statistical measures, and comparative values.

The analysis properties 230 may serve multiple purposes within the system. They may provide the factual foundation for the natural language insights, ensuring that the generated text is grounded in actual data rather than hallucinated information. The properties may also be used to construct prompts for the large language models, providing the necessary context and data points for generating accurate and relevant responses. Additionally, the analysis properties 230 may be used to determine appropriate visualizations and to guide the narrative structure of the insights.

The user interface 200 may support interactive exploration of data. Users may click on elements of the chart 202 to request explanations or additional insights about specific data points. The system may respond to these interactions by generating new insights or by providing more detailed analysis of the selected elements. This interactive capability may be supported by the associative engine 170. The associative engine 170 can quickly retrieve relevant contextual information about any selected data point or visualization element. The chart 202 and the insights 220 may be dynamically updated based on user interactions. For example, if a user selects a particular bar in the chart 202, the system 150 may generate new insights specific to that selection. This interactive capability may be facilitated by the associative engine 170. The associative engine 170 can quickly retrieve and analyze relevant data based on user selections.

The user interface 200 may also include additional interactive elements not explicitly shown in FIG. 2. These may include filters, dropdown menus, or buttons that allow users to refine their queries, change data views, or access additional features of the system 150. The integration of natural language input, visual data representation, and AI-generated insights in a single interface demonstrates the system's capability to provide a comprehensive analytical experience. This approach may allow users of varying technical expertise to gain valuable insights from complex data sets.

The user interface 200 may be part of a larger application or dashboard system. It may be one of several “sheets” within an analytics app, as described earlier. The data and insights presented in the user interface 200 may be derived from the data model and connections established within such an app. The system 150 may use both the vector database 156 and the associative engine 170 to generate the content displayed in the user interface 200. The vector database 156 may provide relevant context and background information based on the user's query, while the associative engine 170 may perform real-time calculations and data retrievals to support the insights and visualizations.

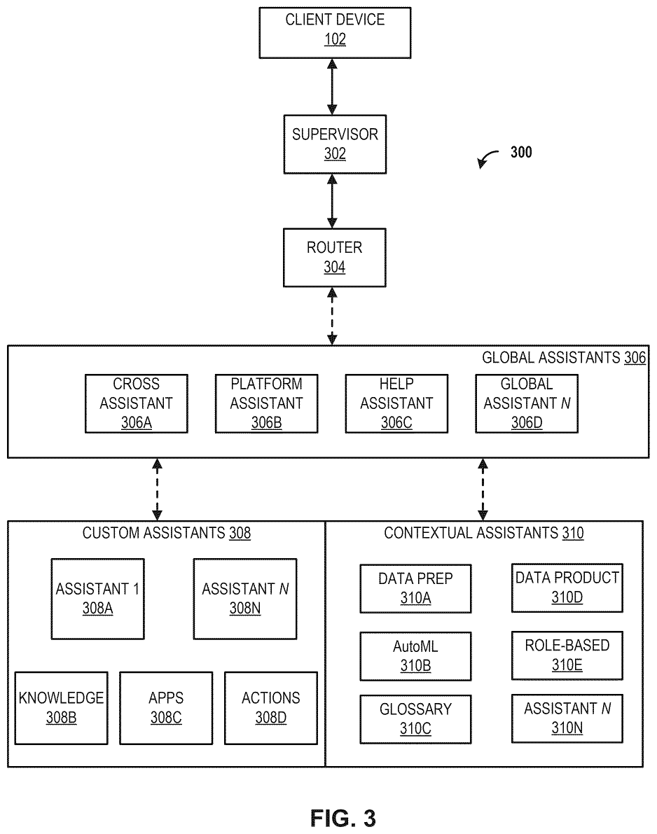

Referring to FIG. 3, an architecture 300 illustrates a multi-tiered assistant system for processing queries from a client device 102. The architecture 300 may operate in conjunction with the system 100 of FIG. 1A and the system 150 of FIG. 1B. For example, the architecture 300 may utilize the ML module 102A and the associative engine 102B of the client device 102 shown in FIG. 1A to process queries and generate responses. The architecture 300 may further utilize the vector database 156, the assistant application 158, and the large language model 160 of the system 150 shown in FIG. 1B to retrieve context and generate answers to natural language questions. The architecture 300 may operate within a multi-tenant cloud platform. Each tenant may have isolated access to tenant-specific assistants within the architecture 300. In some cases, the system may be embedded in external portals or applications. This embedding capability may allow users to access the functionality of the system from within other software environments or platforms. The embedded system may maintain its full range of capabilities, including access to the various tiers of assistants described in the architecture 300.

With continued reference to FIG. 3, the architecture 300 comprises a supervisor 302. The supervisor 302 may receive and analyze user queries from the client device 102. The supervisor 302 may be a component that interacts with a user. In some cases, the supervisor 302 may be responsible for processing initial queries from the user. The supervisor 302 may perform intent recognition on received queries. For example, the supervisor 302 may determine the type of query and the appropriate assistant to handle the query based on the recognized intent. The supervisor 302 may analyze the content and context of a user's query to determine the underlying intent or purpose of the query. The supervisor 302 may utilize the large language model 160 of FIG. 1B to perform intent recognition. Other configurations are possible as well.

The architecture 300 further comprises a router 304. The router 304 may be in communication with the supervisor 302. The router 304 may be responsible for directing queries to appropriate components of the system based on the intent recognized by the supervisor 302. The router 304 may direct queries to appropriate assistants based on the intent determined by the supervisor 302. For example, the router 304 may route a query to a platform-level assistant or to a user-created assistant based on the recognized intent. In some cases, the router 304 may use the intent information to determine which specific assistant or module within the system is best suited to handle the user's query. The router 304 may ensure that users have permissions to access particular assistants before routing queries to those assistants. The supervisor 302 and the router 304 may work in conjunction to process and route user queries efficiently. For example, when a user submits a query, the supervisor 302 may first analyze the query to determine its intent. The supervisor 302 may then pass this intent information to the router 304. The router 304 may use this intent information to direct the query to the appropriate component of the architecture 300 for further processing.

As further shown in FIG. 3, the architecture 300 comprises global assistants 306. The global assistants 306 may comprise a set of platform-level assistants. The global assistants 306 may process and respond to various types of user queries. In some cases, the global assistants 306 may receive queries from the supervisor 302 and the router 304 after initial processing and routing. The global assistants 306 may be maintained by a platform provider and may be available to all tenants of the multi-tenant cloud platform. The global assistants 306 include a cross assistant 306A. The cross assistant 306A may be configured to handle queries requiring coordination between multiple specialized assistants. In some cases, the cross assistant 306A may integrate information from various sources to provide comprehensive responses to complex queries. The global assistants 306 include a platform assistant 306B. The platform assistant 306B may be configured to handle platform-specific actions. For example, the platform assistant 306B may handle user management tasks and data sharing tasks within the system. In some cases, the platform assistant 306B may process queries related to system configuration, user management, or other platform-level operations. The global assistants 306 include a help assistant 306C. The help assistant 306C may be configured to provide assistance with product documentation and usage. In some cases, the help assistant 306C may access a knowledge base of product information to answer user queries about features, functionality, or troubleshooting. The global assistants 306 include a global assistant N 306D. The global assistant N 306D may represent additional extensible assistants within the global assistants 306 tier. These additional assistants may be designed to address specific domains or functionalities within the architecture 300.

The architecture 300 comprises custom assistants 308. The custom assistants 308 may be user-created assistants. The custom assistants 308 may be user-generated or user-created assistants tailored to specific needs or use cases. In some cases, the custom assistants 308 may be designed to handle specialized queries or perform specific tasks that are not covered by the global assistants. The custom assistants 308 may be tenant-specific agents. Each tenant may have isolated access to custom assistants 308 created within that tenant. The custom assistants 308 include an assistant 1 308A and an assistant N 308N. The assistant 1 308A and the assistant N 308N may be designed for specialized tasks within a particular domain or business function.

The custom assistants 308 may be composed of three core components. The three core components include knowledge 308B, apps 308C, and actions 308D. The knowledge 308B may represent knowledge bases containing unstructured data sources. For example, the knowledge 308B may include documents, wikis, policy repositories, and other unstructured information sources. The knowledge 308B may be indexed and stored in the vector database 156 of FIG. 1B. The knowledge 308B may be populated with domain-specific information, which may include both structured and unstructured data. Users may input documents, databases, or other data sources into the knowledge 308B to provide the assistant with the necessary context for answering queries within its specialized domain. In some aspects, access control may be implemented within the knowledge 308B to restrict access to sensitive information. This may involve assigning different permission levels to users or groups, allowing administrators to control who can view, edit, or utilize specific data within the knowledge base. The access control system may integrate with the organization's existing identity management infrastructure to streamline user authentication and authorization.

Additionally, the knowledge 308B may support data encryption at rest and in transit to further enhance security. Audit logging capabilities may also be included to track access and changes to the knowledge base, providing accountability and enabling compliance with data governance policies. The granular access controls within the knowledge 308B may allow organizations to securely share domain-specific knowledge while protecting confidential or proprietary information. The apps 308C may represent linked analytics applications containing structured data through pre-built data models. For example, the apps 308C may include applications exposing semantic data models with dimensions, metrics, and relationships. The apps 308C may be configured to work with applications or other analytics tools. Users may define the types of data analysis and visualizations that the assistant can perform or generate. The apps 308C may interact with an associative engine to process structured data efficiently. The apps 308C may be queried using the associative engine 170 of FIG. 1B. The actions 308D may represent automation workflows. The automation workflows may be triggered based on query results. For example, the actions 308D may include communication workflows, CRM integration workflows, ticketing workflows, and data operations workflows. The actions 308D may be programmed to execute specific tasks or workflows based on user queries or system-generated insights. Users may define custom actions such as generating reports, sending notifications, or triggering external processes. The custom assistants 308 may have the capability to perform actions based on the insights derived from data analysis, such as creating reminders, updating records, or triggering automated processes.

The custom assistants 308 may be created without code. A graphical configuration interface may be used to bind the knowledge 308B, the apps 308C, and the actions 308D together. For example, an administrator may use the graphical configuration interface to select knowledge bases, analytics applications, and automation workflows to associate with a custom assistant. The graphical configuration interface may further allow the administrator to define access rules for different user roles. In some aspects, users may create the custom assistants 308 by defining specific functionalities and knowledge domains. The creation process may involve configuring the knowledge 308B with relevant information, setting up the apps 308C with desired analytics capabilities, and programming the actions 308D to perform specific tasks.

With continued reference to FIG. 3, the architecture 300 comprises contextual assistants 310. The contextual assistants 310 may be domain-specific assistants tailored to particular contexts within the platform. In some cases, the contextual assistants 310 may have access to specialized knowledge bases or data sources relevant to their particular contexts. The contextual assistants 310 may be designed to provide assistance within specific domains or industries. The contextual assistants 310 include a data prep 310A assistant. The data prep 310A assistant may be configured for data preparation tasks. The contextual assistants 310 include an AutoML 310B assistant. The AutoML 310B assistant may be configured for machine learning task assistance. The contextual assistants 310 include a glossary 310C assistant. The glossary 310C assistant may be configured for terminology and definitions. The contextual assistants 310 include a data product 310D assistant. The data product 310D assistant may be configured for data product related queries. The contextual assistants 310 include a role-based 310E assistant. The role-based 310E assistant may be configured for role-specific assistance. The contextual assistants 310 include an assistant N 310N. The assistant N 310N may represent additional contextual assistants within the contextual assistants 310 tier.

Both the custom assistants 308 and the contextual assistants 310 may integrate with the overall architecture 300. In some cases, these assistants may receive queries routed from the supervisor 302 and the router 304 or the global assistants 306. The custom assistants 308 and contextual assistants 310 may process these queries using their specialized knowledge or capabilities. The custom assistants 308 and contextual assistants 310 may interact with other components of the system, such as the vector database 156 and the large language model 160. In some cases, these assistants may use the vector database 156 to retrieve relevant information for processing queries. The custom assistants 308 and contextual assistants 310 may also utilize the large language model 160 to generate responses or perform specific tasks. The integration of custom assistants 308 and contextual assistants 310 into the architecture 300 may allow the system to handle a wide range of specialized queries and tasks. This integration may enable the system to provide tailored assistance across various domains and use cases.

The architecture 300 may operate within a three-tier hierarchy. A first tier may comprise a cloud assistant tier. The cloud assistant tier may include the supervisor 302 and the router 304. The cloud assistant tier may perform intent recognition and routing of queries. The cloud assistant tier may not directly execute business logic. The cloud assistant tier may serve as an initial point of contact for user queries. The cloud assistant tier may receive queries from various user interfaces or input methods. These queries may then be processed by the supervisor 302 and routed by the router 304 to other components of the architecture 300. The cloud assistant tier may be designed to handle a wide range of query types and intents. This versatility may allow architecture 300 to efficiently process and respond to diverse user needs and requests. The cloud assistant tier may also be scalable, allowing it to handle multiple user queries simultaneously and route them to appropriate system components for parallel processing. A second tier may comprise a global assistants tier. The global assistants tier may include the global assistants 306. The global assistants tier may provide platform-maintained assistants available to all tenants.

The modules within the global assistants 306 may interact with each other and with other components of the system to process queries and generate responses. For example, the platform assistant 306B may communicate with the assistant application 158 to execute platform-specific actions. The help assistant 306C may access the vector database 156 to retrieve relevant documentation for user queries. In some cases, the global assistants 306 may use the large language model 160 to process natural language queries and generate human-like responses. The global assistants 306 may also interact with the contextual assistants 310 to provide domain-specific information when needed. The global assistants 306 may be designed to handle a wide range of query types efficiently. By incorporating specialized modules, the global assistants 306 may provide accurate and relevant responses to diverse user needs within the system. A third tier may comprise a custom assistants tier. The custom assistants tier may include the custom assistants 308. The custom assistants tier may provide user-created tenant-specific assistants. The custom assistants tier may be subject to fine-grained access controls.

The hierarchical arrangement may allow the architecture 300 to process queries through multiple tiers and direct queries to appropriate assistants based on recognized intent and user permissions. The components of the architecture 300 may work together to process user queries and generate appropriate responses. For example, a query received by the cloud assistant tier may be routed to an appropriate assistant in the global assistants 306, which may then utilize relevant contextual assistants 310 or custom assistants 308 to generate a comprehensive response.

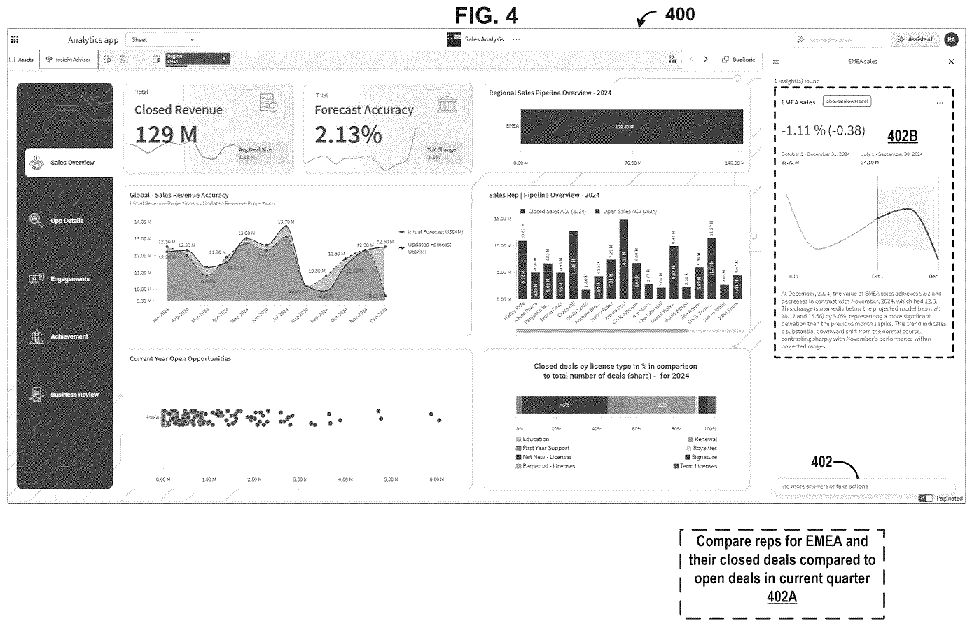

Referring to FIG. 4, an analytics interface 400 may integrate with the assistant application 158 and the architecture 300 described above with reference to FIGS. 1A, 1B, and 3. The analytics interface 400 may be a component of the assistant application 158 and/or any of the assistants within the architecture 300. The analytics interface 400 may provide a unified environment for data visualization and natural language interaction. In some cases, the analytics interface 400 may be used to present data and visualizations to users. The analytics interface 400 may also allow users to interact with the data and initiate queries. The analytics interface 400 may be displayed on the client device 102 and may communicate with the various components of the architecture 300 to process user queries and present analytical results. The analytics interface 400 may display multiple visualizations simultaneously. These visualizations may include various types of charts and graphs. In some cases, the visualizations may be generated based on the data processed by the system organized and operating according to the architecture 300.

The analytics interface 400 may include a chatbox 402. The chatbox 402 may be positioned on a side of the analytics interface 400. In some cases, the chatbox 402 may allow users to input natural language queries. The chatbox 402 may enable users to interact with the system using natural language. The chatbox 402 may include a natural language query 402A. The natural language query 402A may be an input field where users can type questions or commands. For example, the natural language query 402A shown in FIG. 4 reads “Compare reps for EMEA and their closed deals compared to open deals in current quarter.” The natural language query 402A may be an example of a question that a user may input into the system. The chatbox 402 may further include a response text 402B. The response text 402B may be an area where the system displays answers or feedback responsive to the natural language query 402A. The chatbox 402 may display responses generated by the assistant application 158.

These responses may be based on the context 166 retrieved from the vector database 156 and processed by the large language model 160. In some cases, the responses displayed in the chatbox 402 may provide contextual information about the visualizations shown in the main area of the analytics interface 400. The response text 402B may provide analytical information derived from processing the natural language query 402A through the architecture 300. The ability to handle natural language queries may be facilitated by the large language model 160 described in FIG. 1B, which may be integrated into the architecture 300. The response text 402B may be generated by the appropriate assistant within the global assistants 306 or the contextual assistants 310, depending on the nature of the query. The response text 402B may be formulated using data retrieved from the vector database 156 and processed by the large language model 160.

With continued reference to FIG. 4, the analytics interface 400 may display multiple visualizations in a main area adjacent to the chatbox 402. The visualizations may present data in various formats. For example, the visualizations may include charts, graphs, scatter plots, or tables. The visualizations may be generated using data processed by components of the architecture 300. For example, the visualizations may be generated by the global assistants 306 or the custom assistants 308. The analytics interface 400 may allow users to interact with the displayed visualizations. Users may be able to click on specific data points or chart elements to drill down into more detailed information. In some cases, these interactions may trigger new queries or analyses, which may be processed by the system and the architecture 300. The visualizations displayed in the analytics interface 400 may be dynamically updated based on user interactions and queries. The analytics interface 400 may provide tools for users to customize the displayed visualizations. Users may be able to change chart types, adjust data ranges, or apply filters. In some cases, the analytics interface 400 may include features for collaboration. Users may be able to share specific views or analyses with other users. The interface may also support annotations or comments on visualizations, allowing users to discuss insights directly within the analytics environment. The analytics interface 400 may be designed to be responsive and adapt to different screen sizes and devices. This responsiveness may allow users to access and interact with the analytics interface 400 from various devices, including desktop computers, tablets, and smartphones.

The analytics interface 400 may support dynamic interaction between the visualizations and the chatbox 402. A user may click on a specific element of a visualization. The click action may automatically generate a query in the chatbox 402. This interaction may demonstrate the integration between the various components of the architecture 300, such as the global assistants 306 and the contextual assistants 310. The chatbox 402 may then process the generated query through the supervisor 302 and the router 304 of the architecture 300. The router 304 may direct the query to an appropriate assistant within the global assistants 306 or the custom assistants 308.

The analytics interface 400 may also include tools for customizing the displayed visualizations. These tools may allow users to adjust parameters, apply filters, or change chart types. This functionality may be supported by the custom assistants 308 within the architecture 300, which may be designed to handle specific types of data manipulation or visualization tasks. In some cases, the analytics interface 400 may provide options for sharing or exporting insights. These features may be facilitated by the platform assistant 306B within the global assistants 306 of the architecture 300. The platform assistant 306B may handle tasks related to user management and data sharing within the system. Further, the analytics interface 400 may be designed to be responsive and adaptable to different devices and screen sizes. This adaptability may be managed by components within the global assistants 306 of the architecture 300, ensuring a consistent user experience across various devices.

As further shown in FIG. 4, the analytics interface 400 may enable a single custom assistant within the custom assistants 308 to be linked to multiple analytics applications. The custom assistant may reason across the multiple analytics applications in a single query. The associative engine 102B may manage correlations between the multiple analytics applications. The associative engine 102B may discover relationships between the analytics applications based on common field values. The associative engine 102B may maintain bidirectional associations without requiring explicit join specifications.

In some cases, the custom assistants 308 may utilize an associative engine when querying structured data, which may offer several advantages over traditional SQL-based methods. The associative engine may maintain the selection state of prior queries, allowing it to build upon previous results without needing to rerun entire queries. This approach may be particularly beneficial in scenarios involving chain-of-thought reasoning or recursive questioning. Unlike SQL-based systems that often rely on predefined joins, the associative engine may treat all data relationships as full outer joins at runtime. This approach may allow for more comprehensive data exploration and may reveal unexpected insights.

The system may maintain a shared selection state across multiple analytics applications when a user interacts with a custom assistant through the chatbox 402. Filters applied in one analytics application may automatically propagate to related data in other analytics applications. For example, when a user selects a specific data point in one visualization, other visualizations in the analytics interface 400 may update to show related information. The associative engine 102B may facilitate the dynamic updating of the visualizations based on the shared selection state.

The selection state may be stored per session. The session may be identified by a session ID linked to the user and the custom assistant. The session-based storage of the selection state may enable context continuity across multiple related questions. A user may ask multiple related questions without restating filters. Each follow-up query may reuse the cached selection state. The interaction between the user, the assistant application 158, and the large language model 160 may be iterative. In some cases, the system may engage in a multi-turn conversation with the user, refining and expanding upon the initial question and answer. This iterative process may allow for more comprehensive and accurate responses to complex queries.

The associative engine 102B may provide a power of gray capability. The power of gray capability may reveal related insights not explicitly queried. The power of gray capability may show data that does not match the query criteria. The revealed data may provide valuable insights that might otherwise be overlooked. Additionally, the associative engine may provide the ability to answer not only the specific question asked but also related questions that were not explicitly stated. This may allow the system to show data that does not match the query criteria, potentially revealing valuable insights that might otherwise be overlooked. For example, the associative engine may analyze relationships between data points that were not directly queried, uncovering hidden patterns or correlations. It may also present contextually relevant information alongside the direct query results, giving users a more comprehensive view of the data landscape. In some cases, this capability may lead to serendipitous discoveries, where users gain unexpected insights from data they did not initially consider relevant. The associative engine 102B may accomplish this by maintaining a holistic view of the entire dataset, allowing it to draw connections across different dimensions and data sources.

This approach may be particularly useful in complex analytical scenarios where the relationships between different data elements are not immediately apparent. By surfacing these additional insights, the associative engine 102B may enhance the exploratory nature of data analysis, potentially leading to more informed decision-making and a deeper understanding of the underlying data structures and relationships. The associative engine 102B may use incremental calculation with cached indexed in-memory data structures. The incremental calculation may enable query execution in milliseconds. Other examples are possible as well.

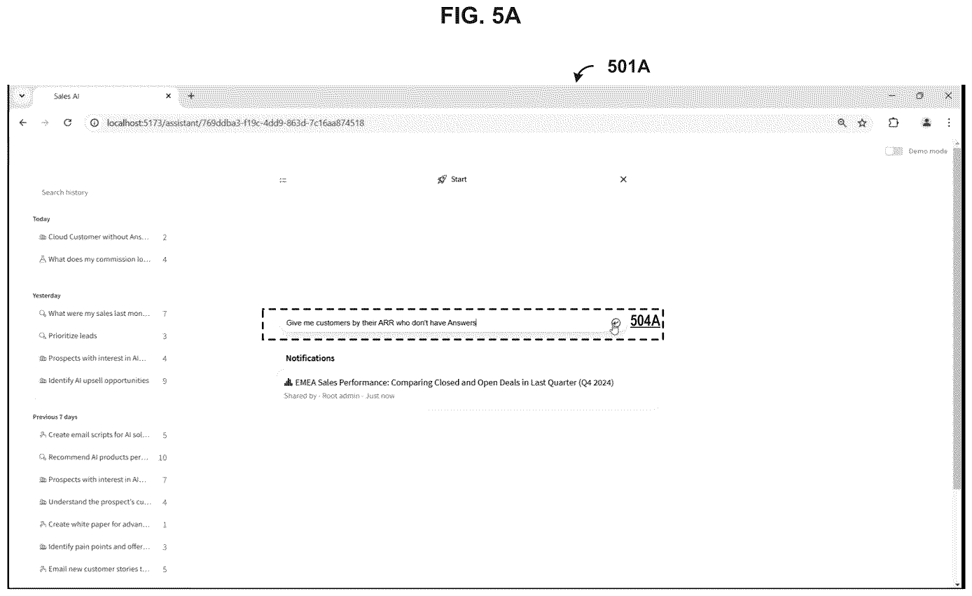

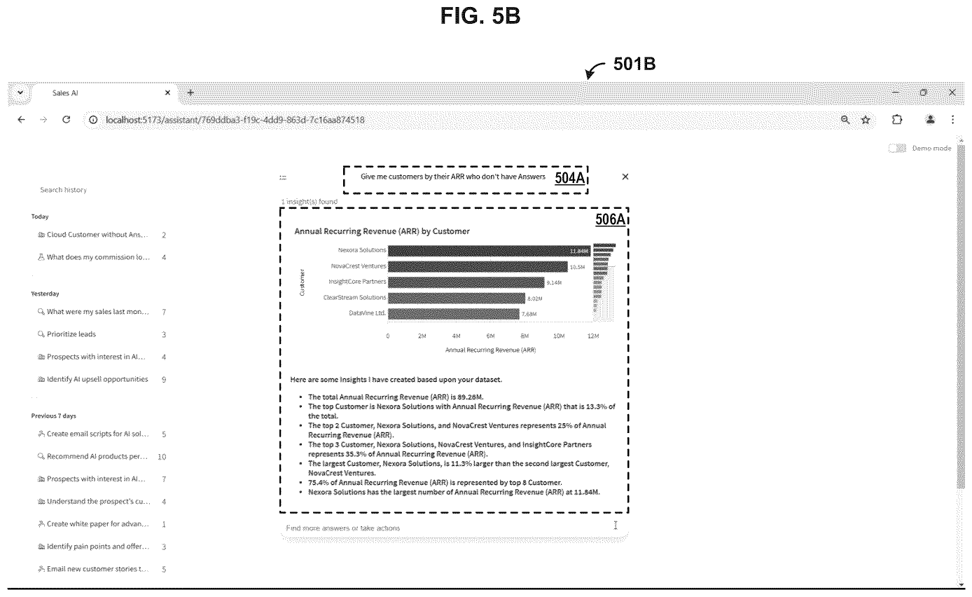

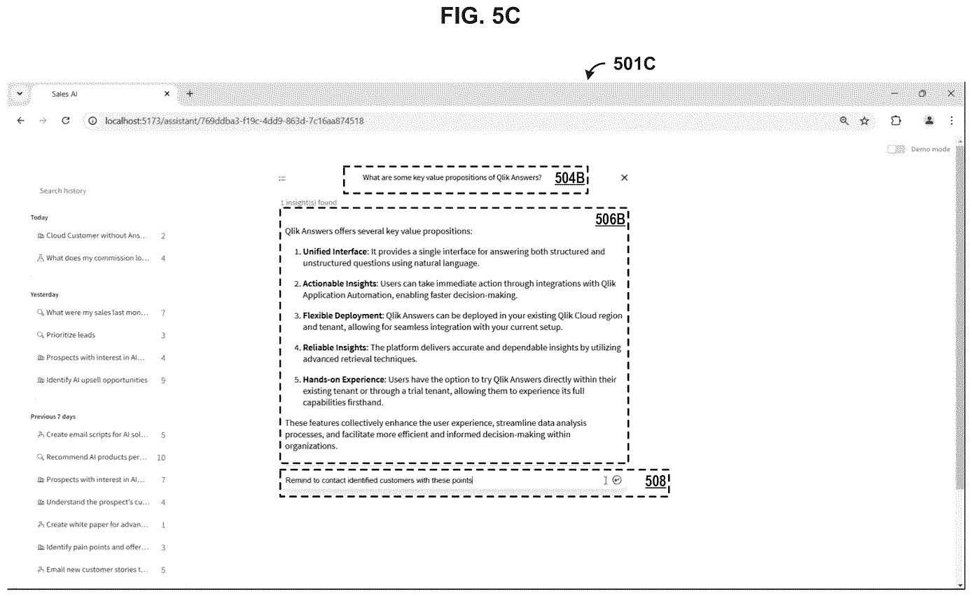

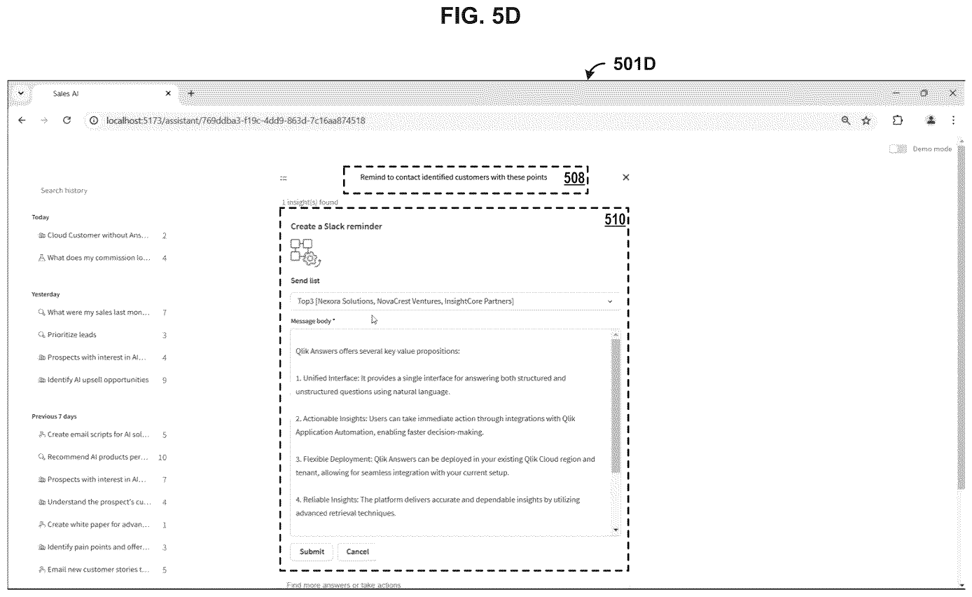

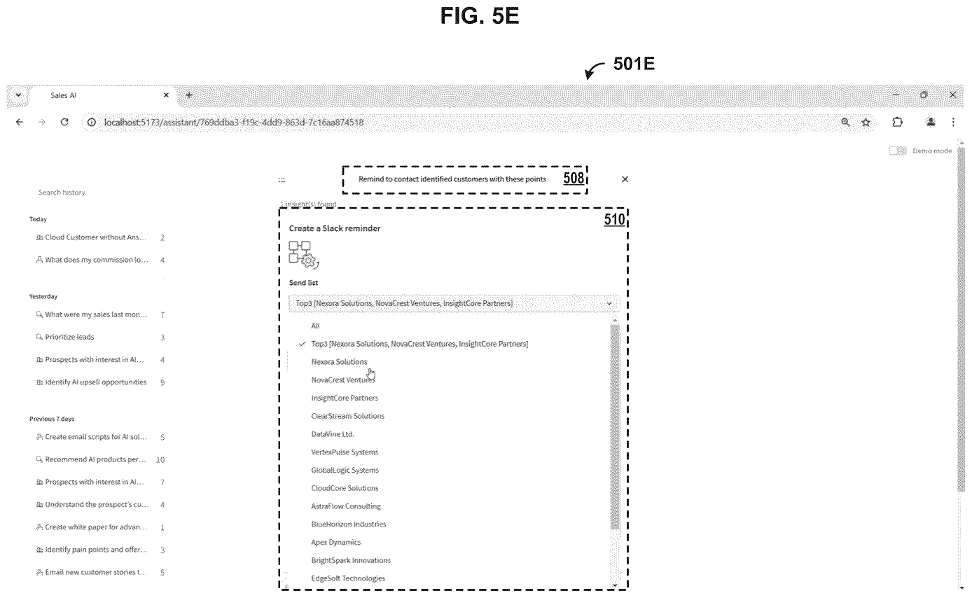

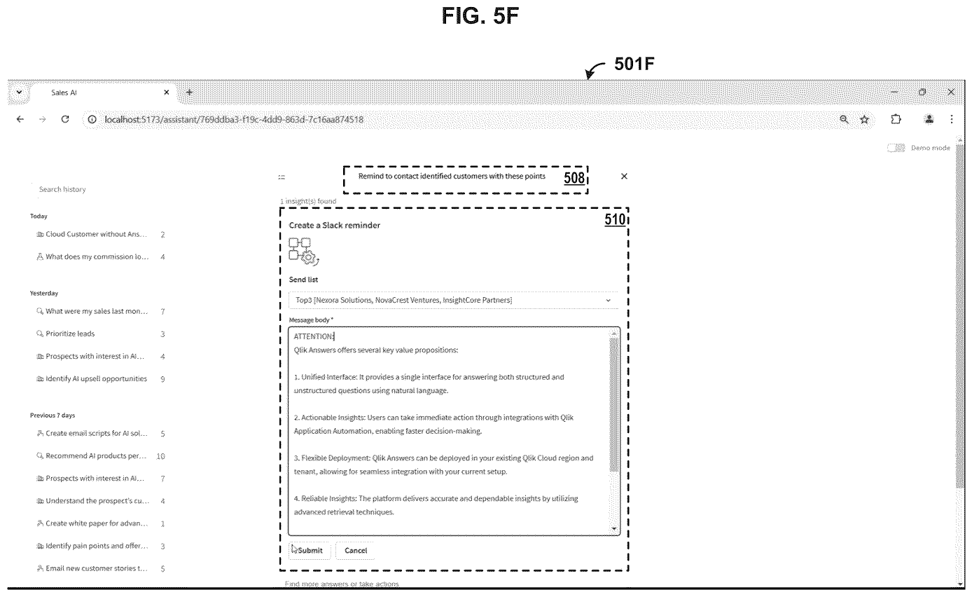

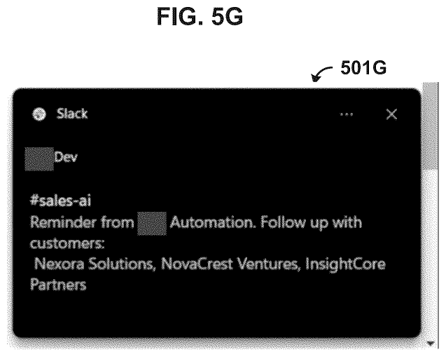

Referring to FIGS. 5A-5G, an analytics session is illustrated in which a user interacts with multiple interfaces of a custom assistant 308 of the architecture 300. The analytics session demonstrates a continuous workflow from query submission through response generation to automated action execution. The analytics session may enable user interaction with the custom assistants 308 through a graphical configuration interface.

As shown in FIG. 5A, the analytics session may begin with a first analytics interface 501A displayed to a user of the system 150. The first analytics interface 501A may include a query input field positioned in a central area of the display. A user may submit a user question 504A to a custom assistant 308 through the query input field. The user question 504A may comprise a natural language query. For example, the user question 504A shown in FIG. 5A reads “Give me customers by their ARR who don't have Answers.” The user question 504A may be processed by the custom assistant 308 to retrieve relevant information from linked knowledge bases and analytics applications.

With continued reference to FIG. 5A, the first analytics interface 501A may include a search history panel positioned on a left side of the display. The search history panel may display previously submitted queries organized by time periods. The time periods may include Today, Yesterday, and Previous 7 days. Each query entry within the search history panel may show a brief description and a numerical indicator. The search history panel may allow users to view and access previously submitted queries. The search history panel may enable users to select a prior query for re-execution or modification.

As shown in FIG. 3, when the user question 504A is submitted through the first analytics interface 501A, the supervisor 302 from the architecture 300 may receive the query. The supervisor 302 may perform intent recognition on the user question 504A. The supervisor 302 may coordinate with the router 304 to determine an appropriate processing path for the user question 504A. The router 304 may direct the user question 504A to the appropriate custom assistant 308 based on the recognized intent.

Referring to FIG. 1B, the custom assistant 308 may access the vector database 156 to retrieve context 166 relevant to the user question 504A. The custom assistant 308 may utilize knowledge 308B associated with the custom assistants 308. The knowledge 308B may represent knowledge bases containing unstructured data sources. The knowledge bases may support multiple content types. For example, the knowledge bases may support PDF files, Microsoft Word documents, and plain text files. The knowledge bases may also support HTML pages from internal portals and external websites. Other content types are possible as well.

Continuing the analytics session, FIG. 5B depicts a second analytics interface 501B that displays the user question 504A and a corresponding answer 506A generated by the custom assistant 308. The user question 504A may comprise the natural language query entered by the user in the first analytics interface 501A. For example, the user question 504A may read “Give me customers by their ARR who don't have Answers.” The answer 506A may be displayed below the user question 504A in a dedicated response area of the second analytics interface 501B. The answer 506A may be generated by the custom assistant 308 in response to the user question 504A. For example, the custom assistant 308 may be the assistant 1 308A within the custom assistants 308 of the architecture 300 shown in FIG. 3.

With reference to FIG. 1B, the custom assistant 308 may process the user question 504A by accessing the vector database 156 to retrieve relevant information. The vector database 156 may store embeddings representing semantic content of data sources associated with the custom assistant 308. The custom assistant 308 may perform a similarity search within the vector database 156 to identify embeddings semantically related to the user question 504A. The similarity search may return context 166 comprising passages or data elements relevant to the user question 504A.

The custom assistant 308 may provide the retrieved context 166 to the large language model 160. The large language model 160 may process the context 166 along with the user question 504A to generate a comprehensive response. The large language model 160 may synthesize the relevant information into a coherent textual output. The large language model 160 may format the response to highlight analytical observations derived from the processed data.

With continued reference to FIG. 5B, the answer 506A may include visualizations and insights. For example, the answer 506A may include a bar chart visualization showing Annual Recurring Revenue by Customer. The bar chart may display customer names along a vertical axis and revenue values along a horizontal axis. The bar chart may display multiple horizontal bars representing different customers with corresponding revenue values labeled on each bar.

The answer 506A may further include a textual insights section positioned adjacent to the bar chart. The textual insights section may provide analytical observations about the dataset. For example, the textual insights section may include information about total Annual Recurring Revenue, percentage contributions of top customers, and comparative analysis between customer revenue values.

Referring again to FIG. 3, the custom assistant 308 may be linked to multiple knowledge bases through the knowledge 308B component. When the custom assistant 308 is linked to multiple knowledge bases, queries may span all of the linked knowledge bases. Results from the multiple knowledge bases may be consolidated and ranked by relevance. The consolidation and ranking may be performed by the custom assistant 308 or by the large language model 160. The custom assistant 308 may respect per-user permission filtering when retrieving results from the multiple knowledge bases. For example, a user may have access to a first knowledge base but not a second knowledge base. In such cases, the custom assistant 308 may return results from the first knowledge base while filtering out results from the second knowledge base based on the user's permissions.

Continuing the analytics session, FIG. 5C depicts a third analytics interface 501C in which the user submits a follow-up query to the custom assistant 308. The third analytics interface 501C may display information related to a second user question 504B and a corresponding second answer 506B within the same analytics session. The second user question 504B may be displayed in an upper portion of the third analytics interface 501C. The second user question 504B may comprise a natural language query entered by the user.

With continued reference to FIG. 5C, the second answer 506B may be displayed below the second user question 504B in a dedicated response area. The second answer 506B may be generated by the custom assistant 308 in response to the second user question 504B. The second answer 506B may include a textual response listing information retrieved from knowledge bases and analytics applications associated with the custom assistant. For example, the second answer 506B may list value propositions including a unified interface for answering structured and unstructured questions using natural language, actionable insights through integrations with application automation, flexible deployment options, and reliable insights utilizing advanced retrieval techniques. The custom assistant 308 may utilize the vector database 156 shown in FIG. 1B to retrieve relevant information for generating the second answer 506B. The custom assistant 308 may further utilize the large language model 160 shown in FIG. 1B to process the retrieved information and generate the second answer 506B.

As further shown in FIG. 5C, the third analytics interface 501C may include an action request 508 positioned below the second answer 506B. The action request 508 may allow the user to initiate a specific action based on the information provided in the second answer 506B. For example, the action request 508 may read “Remind to contact identified customers with these points.” The action request 508 may be presented as a button or interactive element within the third analytics interface 501C. The action request 508 may enable users to trigger automation workflows based on insights generated from queries within the analytics session.

The automation workflows may comprise trigger conditions, data transformations, action sequences, and error handling components. The trigger conditions may define when a workflow executes. For example, a trigger condition may specify that a workflow executes when a custom assistant identifies a high-risk customer. The data transformations may define how query results are formatted for a target system. For example, a data transformation may map a customer identifier to a corresponding account identifier in a customer relationship management system. The action sequences may define specific actions that execute in order. For example, an action sequence may send an email, create a task, and log an event. The error handling components may define behavior when an action fails. For example, an error handling component may retry an action, escalate to a supervisor, or log an error.

As further shown in FIG. 3, the custom assistants 308 may include actions 308D representing automation workflows. The workflow types may include communication workflows, CRM integration workflows, ticketing workflows, data operations, and administrative workflows. The communication workflows may include email campaigns, messaging platform notifications, and SMS alerts. The CRM integration workflows may create or update records in customer relationship management systems. The ticketing workflows may open support tickets in ticketing systems. The data operations may trigger data reloads, generate reports, and export data. The administrative workflows may provision users, update security groups, and modify permissions.

The automation workflows may implement closed-loop intelligence following a query-analyze-act pattern. The query-analyze-act pattern may enable insights from analytics to trigger automated actions. For example, a user may submit a query through the third analytics interface 501C. The custom assistant 308 may analyze the query and generate the second answer 506B containing insights. The user may then select the action request 508 to trigger an automation workflow based on the generated insights. The automation workflow may execute actions in external systems based on the query results. For example, the automation workflow may send a notification to a messaging platform, create a task in a customer relationship management system, or generate a report. The closed-loop intelligence configuration may streamline workflows and enable real-time responsiveness to data-driven insights. The system 100 shown in FIG. 1A may facilitate communication between the custom assistant 308 and external systems through the network 104.

Continuing the analytics session, FIG. 5D depicts a fourth analytics interface 501D in which the user configures recipients for an automated notification. The fourth analytics interface 501D may be displayed in response to the user selecting the action request 508 shown in FIG. 5C. The fourth analytics interface 501D may include an action request 508 presented as a drop-down menu. The drop-down menu may enable users to select one or more recipients for a notification or alert. The action request 508 may display a list of selectable recipient options. The fourth analytics interface 501D may further include a message body field 510. The message body field 510 may allow users to compose the content of the message to be sent to the selected recipients. The message body field 510 may contain pre-populated text based on prior query results or user interactions from earlier in the analytics session.

With continued reference to FIG. 5D and FIG. 3, the action request 508 may be part of an automation workflow configuration. The automation workflow may be one of the actions 308D associated with the custom assistants 308 of the architecture 300. The workflow attachment may include setting triggering rules for automatic execution conditions. The workflow attachment may also include specifying user permissions for manual invocation. For example, a user may configure the action request 508 to specify that a notification workflow should auto-trigger when certain data conditions are met. Alternatively, the user may configure the action request 508 to require manual approval before execution.

Continuing the analytics session, FIG. 5E depicts a fifth analytics interface 501E in which the user further configures the notification content. The fifth analytics interface 501E may provide the action request 508 and the message body field 510 configured for setting workflow parameters. Users may utilize the action request 508 to define specific workflow conditions. The action request 508 may include a send list field showing selected recipients. The message body field 510 may be positioned below the send list field. The message body field 510 may contain editable text with descriptive content derived from the second answer 506B. For example, the message body field 510 may include information about value propositions such as a unified interface for answering structured and unstructured questions using natural language, actionable insights through integrations with application automation enabling faster decision-making, flexible deployment options in existing cloud regions and tenants, and reliable insights utilizing advanced retrieval techniques.

As further shown in FIG. 5E and with reference to FIG. 1B, the fifth analytics interface 501E may enable configuration of multi-workflow orchestration. A single custom assistant may trigger multiple workflows in sequence. Outputs from one workflow may become inputs to the next workflow in the sequence. For example, a first workflow may send outreach emails to identified customers. A second workflow may create follow-up tasks based on the email send confirmations from the first workflow. A third workflow may generate escalation alerts based on conditions identified in the outputs of the preceding workflows.

Continuing the analytics session, FIG. 5F depicts a sixth analytics interface 501F in which the user finalizes the notification content before submission. The sixth analytics interface 501F may enable users to customize notification content through the action request 508 and the message body field 510. The action request 508 may include a send list field showing selected recipients. The message body field 510 may contain editable text with a header and descriptive content. For example, the message body field 510 may display a header reading “ATTENTION” followed by a subheader reading “Remind to contact identified customers with these points.” The message body field 510 may further display descriptive content about value propositions derived from the insights generated earlier in the analytics session.

With continued reference to FIG. 5F, the sixth analytics interface 501F may additionally include submit and cancel options. The submit and cancel options may be positioned below the message body field 510. The submit option may allow users to confirm their customization selections and initiate the workflow execution. The cancel option may allow users to discard their customization selections without executing the workflow. The workflows may support conditional triggering rules. The conditional triggering rules may determine whether a workflow automatically executes or requires manual approval based on data conditions. For example, a workflow may be configured to auto-trigger when a customer risk score exceeds a threshold value and a customer annual recurring revenue exceeds a specified amount. Alternatively, the workflow may be configured to require manual approval when the risk score falls within a specified range.

Concluding the analytics session, FIG. 5G depicts an automated action interface 501G that displays a notification output generated as a result of the user selecting the submit option in the sixth analytics interface 501F. The automated action interface 501G may present a notification panel with a dark background containing information about a messaging reminder. The notification panel within the automated action interface 501G may show a messaging platform icon and may indicate a source identifier along with a channel designation. The automated action interface 501G may further display a message indicating that the notification is a reminder from an automation system with instructions to follow up with identified customers

With continued reference to FIG. 5G, the automated action interface 501G may include interface controls comprising a menu indicator and a close button positioned in an upper portion of the notification panel. The automated action interface 501G may represent the output of an automation workflow configured and triggered through the custom assistant during the analytics session. The automation workflow may deliver relevant information to a designated messaging platform without requiring manual intervention from a user.

As shown in FIG. 3, the custom assistants 308 may include actions 308D representing automation workflows. The actions 308D may be triggered based on query results generated by the assistant 1 308A or the assistant N 308N. The automation workflows represented by the actions 308D may execute in external systems such as messaging platforms, customer relationship management systems, or ticketing systems.

With reference to FIGS. 1A and 1B, the system 100 and the system 150 may support the execution of automation workflows. The assistant application 158 may process the natural language question 162 and may generate the answer 168. Based on the answer 168, the assistant application 158 may trigger an automation workflow. The automation workflow may transmit notifications or other data through the network 104 to external systems.

The analytics session illustrated in FIGS. 5A-5G demonstrates a closed-loop intelligence pattern. In the closed-loop intelligence pattern, insights derived from analytics may trigger automated actions. The automated actions may be executed in external systems such as messaging platforms. For example, the custom assistant may process analytical output and may identify customers meeting specified criteria as shown in FIG. 5B. The user may submit a follow-up query as shown in FIG. 5C and may initiate a notification workflow through the action request 508. The user may configure recipients and message content as shown in FIGS. 5D-5F. The notification workflow may deliver relevant information to a designated messaging platform as shown in FIG. 5G. The closed-loop intelligence pattern may enable query results to lead to automated actions without requiring manual intervention between the analysis phase and the action phase. Other examples are possible as well.

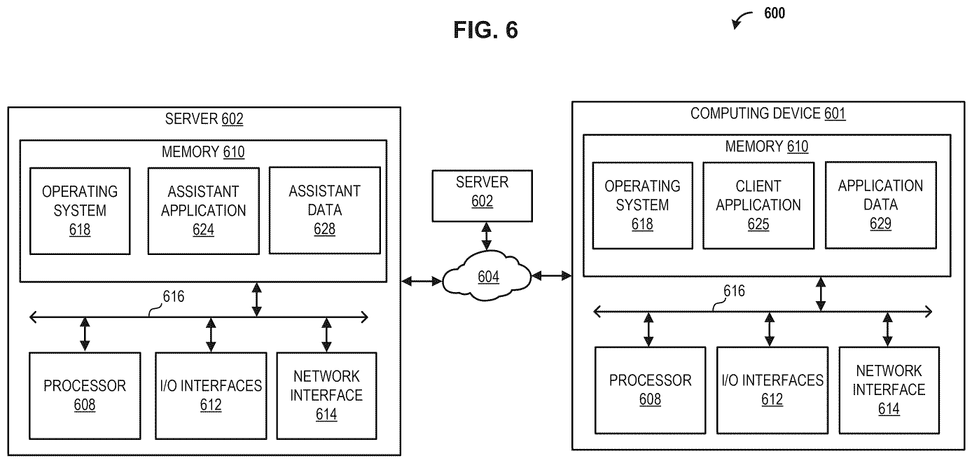

The present methods and systems may be computer-implemented. FIG. 6 shows a block diagram depicting a system/environment 600 comprising non-limiting examples of a computing device 601 and a server 602 connected through a network 604. Either of the computing device 601 or the server 602 may be a computing device, such as any of the devices of the system 100 shown in FIG. 1. In an aspect, some or all steps of any described method may be performed on a computing device as described herein. The computing device 601 may comprise one or multiple computers configured to store application data 629, and/or the like. The server 602 may comprise one or multiple computers configured to store assistant data 629. Multiple servers 602 may communicate with the computing device 601 via the through the network 604.

The computing device 601 and the server 602 may be a digital computer that, in terms of hardware architecture, generally includes a processor 608, system memory 610, input/output (I/O) interfaces 612, and network interfaces 614. These components (608, 610, 612, and 614) are communicatively coupled via a local interface 616. The local interface 616 may be, for example, but not limited to, one or more buses or other wired or wireless connections, as is known in the art. The local interface 616 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 608 may be a hardware device for executing software, particularly that stored in system memory 610. The processor 608 may be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. When the computing device 601 and/or the server 602 is in operation, the processor 608 may execute software stored within the system memory 610, to communicate data to and from the system memory 610, and to generally control operations of the computing device 601 and the server 602 pursuant to the software.

The I/O interfaces 612 may be used to receive user input from, and/or for providing system output to, one or more devices or components. User input may be provided via, for example, a keyboard and/or a mouse. System output may be provided via a display device and a printer (not shown). I/O interfaces 612 may include, for example, a serial port, a parallel port, a Small Computer System Interface (SCSI), an infrared (IR) interface, a radio frequency (RF) interface, and/or a universal serial bus (USB) interface.

The network interface 614 may be used to transmit and receive from the computing device 601 and/or the server 602 on the network 604. The network interface 614 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 614 may include address, control, and/or data connections to enable appropriate communications on the network 604.

The system memory 610 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 610 may incorporate electronic, magnetic, optical, and/or other types of storage media. Note that the system memory 610 may have a distributed architecture, where various components are situated remote from one another, but may be accessed by the processor 608.

The software in system memory 610 may include one or more software programs, each of which comprises an ordered listing of executable instructions for implementing logical functions. In the example of FIG. 6, the software in the system memory 610 of the computing device 601 may comprise the application data 629, the client application 625, and a suitable operating system (O/S) 618. In the example of FIG. 6, the software in the system memory 610 of the server 602 may comprise the assistant data 629, the assistant application 624, and a suitable operating system (O/S) 618. The operating system 618 essentially controls the execution of other computer programs and provides scheduling, input-output control, file and data management, memory management, and communication control and related services.

For purposes of illustration, application programs and other executable program components such as the operating system 618 are shown herein as discrete blocks, although it is recognized that such programs and components may reside at various times in different storage components of the computing device 601 and/or the server 602. An implementation of the system/environment 600 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

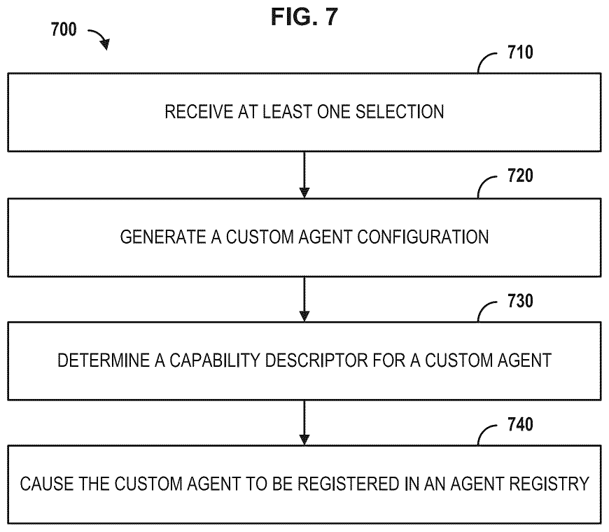

Referring to FIG. 7, a method 700 for creating and registering a custom agent within an assistant platform is illustrated. The method 700 may be performed by one or more computing devices. For example, the method 700 may be performed by the client device 102 of FIG. 1A, the server 106B of FIG. 1A, or a combination thereof. The method 700 may enable business users to construct intelligent agents without coding or data engineering expertise.

At step 710, the method 700 may include receiving at least one selection via a configuration interface of an assistant platform. The configuration interface may be a graphical configuration interface. The at least one selection may include a first selection of a knowledge base, a second selection of an analytics application, and a third selection of an automation workflow. The first selection may comprise selecting multiple knowledge bases from a plurality of available knowledge bases. The knowledge base may comprise unstructured documents indexed in a vector database. For example, the knowledge base may comprise unstructured documents indexed in the vector database 156 of FIG. 1B. The analytics application may be associated with a data model comprising dimensions and metrics. For example, the analytics application may correspond to the apps 308C of FIG. 3. The automation workflow may be configured to perform an action in an external system. For example, the automation workflow may correspond to the actions 308D of FIG. 3.

With continued reference to FIG. 7, the step 710 may further include receiving assistant metadata. The assistant metadata may include a name, a description, a domain tag, an owner, and an update frequency parameter. The domain tag may indicate a business domain such as sales, finance, operations, human resources, or product. The update frequency parameter may specify how often knowledge bases and analytics applications should refresh.

At step 720, the method 700 may include generating a custom agent configuration based on the first selection, the second selection, and the third selection received in the step 710. The custom agent configuration may be associated with the knowledge base, the analytics application, and the automation workflow. The custom agent configuration may link the custom agent configuration to the multiple knowledge bases when the first selection comprises selecting multiple knowledge bases. The custom agent configuration may define associations between the custom agent and the selected components.

The step 720 may include linking knowledge bases to the custom agent. Linking knowledge bases may include setting visibility rules for user roles. The visibility rules may specify which user roles can access each knowledge base. Linking knowledge bases may further include configuring reindexing frequency. The reindexing frequency may be daily, weekly, or on-demand.

The step 720 may include linking analytics applications to the custom agent. Linking analytics applications may include confirming rules for row-level security. The Section Access rules may ensure users only see data rows and columns the users have permission to access. Linking analytics applications may further include specifying refresh cadence. The refresh cadence may be real-time, hourly, or daily.

Referring to FIG. 3, the custom agent configuration generated in the step 720 may correspond to the configuration of the assistant 1 308A within the custom assistants 308. The assistant 1 308A may be associated with the knowledge 308B, the apps 308C, and the actions 308D. The knowledge 308B may represent knowledge bases containing unstructured data sources. The apps 308C may represent linked analytics applications containing structured data through pre-built data models. The actions 308D may represent automation workflows.

With continued reference to FIG. 7, the step 720 may further include receiving, via the configuration interface, a permission specification for the custom agent. The permission specification may restrict access to the custom agent based on a set of user roles. The set of user roles may define authorized interactions. The permission specification may define a first access level and a second access level. The first access level may permit querying the knowledge base. The second access level may permit triggering the automation workflow. The first access level and the second access level may be assigned to distinct user groups identified by the set of user roles.

The access control configuration may define role-based access levels for each combination of user role, component type, specific resource, and permission level. The permission level may include view, query, trigger, and execute. Permissions may be enforced at three distinct layers. A semantic search layer may filter knowledge base results based on visibility rules. A data query layer may apply row-level security for analytics applications. An automation execution layer may control workflow triggering based on user role permissions.

At step 730, the method 700 may include determining, based on the custom agent configuration, a capability descriptor for a custom agent derived from the custom agent configuration. The capability descriptor may specify query types processable by the custom agent. The capability descriptor may indicate that the custom agent can answer queries requiring semantic search of the unstructured documents within the vector database when the knowledge base comprises unstructured documents indexed in the vector database. The capability descriptor may indicate that the custom agent can answer queries requiring evaluation of the dimensions and the metrics within the data model when the analytics application is associated with a data model comprising dimensions and metrics. The capability descriptor may indicate that the custom agent can trigger the action in the external system when the automation workflow is configured to perform an action in an external system.

At step 740, the method 700 may include causing, based on the custom agent configuration, the custom agent to be registered in an agent registry. The agent registry may be accessible to users of the assistant platform. Referring to FIG. 3, the agent registry may enable the router 304 to recognize the custom agent and route queries to the custom agent. The supervisor 302 may access the agent registry to determine available custom agents for processing user queries from the client device 102.

With continued reference to FIG. 7, the step 740 may include a review and validation phase. The review and validation phase may check that all linked knowledge bases exist and are accessible. The review and validation phase may confirm that all linked apps exist and are published. The review and validation phase may validate that all linked workflows are active. The review and validation phase may confirm that all permission rules are valid. The custom assistants may support versioning with version control. Version control may allow draft versions to be developed while published versions remain active for users. The system may support instant rollback to a prior version if a new version introduces problems. The instant rollback may revert all active users to the previous configuration. Other examples are possible as well.

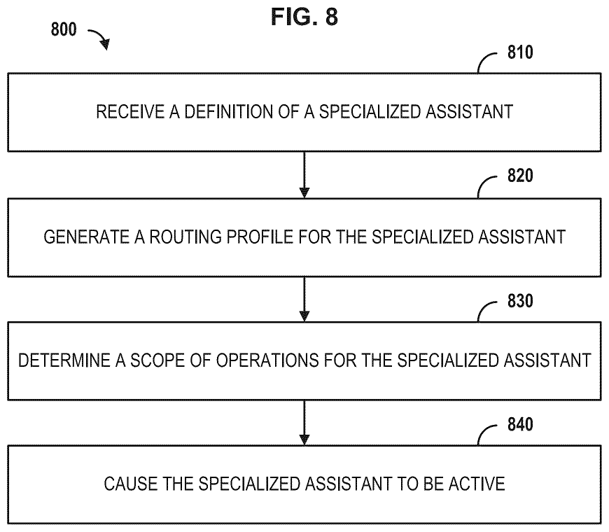

Referring to FIG. 8, a method 800 for creating and activating a specialized assistant is illustrated. The method 800 may be performed by one or more computing devices. For example, the method 700 may be performed by the client device 102 of FIG. 1A, the server 106B of FIG. 1A, or a combination thereof. The method 800 may enable configuration and deployment of specialized assistants that process queries by routing the queries to appropriate data sources based on recognized intents.

At step 810, the method 800 may include receiving, via a configuration tool of an assistant platform, a definition of a specialized assistant. The definition may identify a structured data source and an unstructured data source. The structured data source may comprise an associative data model comprising defined fields. For example, the structured data source may comprise an analytics application exposing a semantic data model with dimensions, metrics, and relationships as described with reference to FIG. 1B. The unstructured data source may comprise a document collection. For example, the unstructured data source may comprise a knowledge base containing documents, web content, or enterprise repository content. The definition may specify which databases, documents, APIs, or other resources the specialized assistant is permitted to access. The definition may further identify an external action script. For example, the external action script may comprise an automation workflow configured to trigger actions in external systems.

With continued reference to FIG. 8, at step 820, the method 800 may include generating, based on the definition, a routing profile for the specialized assistant. The routing profile may map a first set of intents to the structured data source and a second set of intents to the unstructured data source. The first set of intents and the second set of intents may be distinct. The routing profile may map the first set of intents to the defined fields of the associative data model. For example, intents related to quantitative analysis or metric retrieval may be mapped to the structured data source. The routing profile may map the second set of intents to a semantic search process over the document collection. The semantic search process may retrieve content from the document collection. For example, intents related to policy questions or procedural guidance may be mapped to the unstructured data source. Generating the routing profile may comprise mapping, based on the external action script, a third set of intents to the external action script. For example, intents related to triggering notifications or creating records in external systems may be mapped to the external action script.

Generating the routing profile may comprise resolving, based on a priority rule, an overlap between the first set of intents and the second set of intents. The priority rule may define precedence between the structured data source and the unstructured data source. For example, the priority rule may specify that quantitative queries are routed to the structured data source before the unstructured data source when both sources contain relevant information. Referring to FIG. 3, the routing profile may be utilized by the router 304 to direct queries to appropriate components within the architecture 300. The router 304 may examine incoming queries and determine whether to route the queries to the structured data source via the apps 308C or to the unstructured data source via the knowledge 308B.

With continued reference to FIG. 8, at step 830, the method 800 may include determining, based on the routing profile, a scope of operations for the specialized assistant. The scope of operations may define boundaries for the specialized assistant's capabilities, permissions, and allowable actions. For example, the scope of operations may specify which user roles can access which data sources and which workflows can be triggered. At step 840, the method 800 may include causing, based on the scope of operations, the specialized assistant to be active in a runtime environment of the assistant platform. The runtime environment may execute the specialized assistant. Causing the specialized assistant to be active may comprise deploying, based on the routing profile, the specialized assistant to a cloud tenant associated with the configuration tool. The cloud tenant may host the specialized assistant. Once active, the specialized assistant may be available to process requests according to the defined configuration. Referring to FIG. 1A, the runtime environment may comprise the system 100. The specialized assistant may be executed by the client device 102 in communication with the data stores 106, 108, 110 via the network 104. The ML module 102A may process queries received by the specialized assistant. The associative engine 102B may manage associations between data elements when the specialized assistant queries the structured data source.

With continued reference to FIG. 8, receiving the definition may comprise receiving, based on a user input, an update to the definition that adds a new data source. The method 800 may further comprise updating, based on the new data source, the routing profile. For example, an administrator may add a new knowledge base or analytics application to the specialized assistant, and the routing profile may be updated to map additional intents to the new data source.

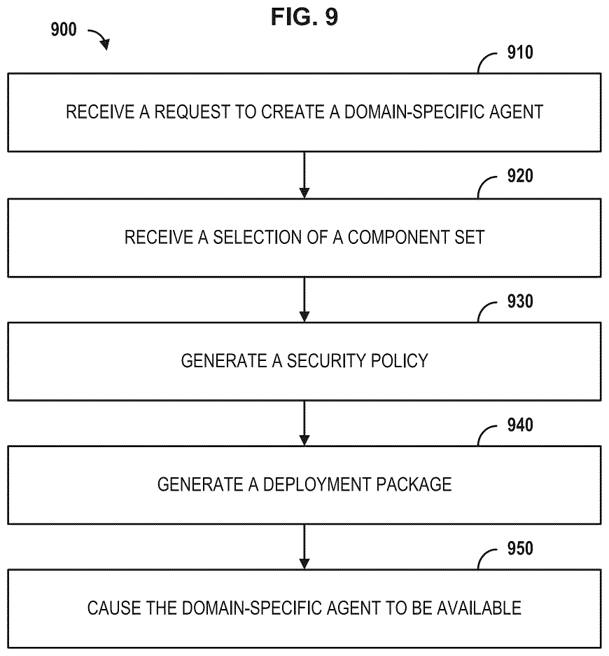

Referring to FIG. 9, a method 900 for creating and deploying a domain-specific agent is illustrated. The method 900 may be performed by one or more computing devices. The method 900 may be performed by components of the system 100 described with reference to FIG. 1A. The method 900 may be performed by components of the system 150 described with reference to FIG. 1B. The method 900 may be performed by components of the architecture 300 described with reference to FIG. 3.

At step 910, the method 900 may include receiving a request to create a domain-specific agent. The request may be received via an administration panel of an analytics platform. The administration panel may provide a graphical configuration interface. The administration panel may allow administrators to define and configure domain-specific agents without requiring coding or data engineering expertise. The request may specify a purpose for the domain-specific agent. The request may specify a target business domain for the domain-specific agent. The request may specify an owner or team responsible for maintaining the domain-specific agent.

With continued reference to FIG. 9, at step 920, the method 900 may include receiving a selection of a component set for the domain-specific agent. The selection may be received based on the request received at the step 910. The component set may comprise an analytics application and a document index. The analytics application may expose a curated data model. The curated data model may comprise dimensions, metrics, and key performance indicators. The document index may comprise indexed collections of unstructured content. The document index may include documents such as PDF files, word processing documents, and plain text files. The document index may include web content such as HTML pages from internal portals and external websites. The document index may include content from enterprise repositories such as document libraries and wikis.

In some cases, the component set may further comprise a workflow automation. The workflow automation may define business processes executable by the domain-specific agent. The workflow automation may include communication workflows for email campaigns, messaging notifications, and alerts. The workflow automation may include integration workflows for creating or updating records in external systems. The workflow automation may include ticketing workflows for opening support tickets in external ticketing systems. The workflow automation may include data operation workflows for triggering data reloads, generating reports, and exporting data.

As further shown in FIG. 9, at step 930, the method 900 may include generating a security policy for the domain-specific agent. The security policy may be generated based on the selection received at the step 920. The security policy may define user groups authorized to access the analytics application and the document index through the domain-specific agent. The security policy may implement multi-layered permission controls.

In some cases, the analytics application may be governed by a first access control list. The generating the security policy may comprise inheriting permission rules for the domain-specific agent based on the first access control list. The permission rules may determine access rights. The permission rules may specify view permissions, query permissions, trigger permissions, and execute permissions for different user roles. In some cases, the security policy may restrict access to the document index based on a user attribute associated with the user groups. The user attribute may indicate a clearance level. The user attribute may indicate a user role. The security policy may enforce row-level security through section access rules. The security policy may ensure users only see data rows and columns the users have permission to access. In some cases, where the component set comprises the workflow automation, the security policy may include a distinct execution permission for the workflow automation. The distinct execution permission may authorize initiation of the workflow automation. The distinct execution permission may specify conditions under which the workflow automation auto-triggers. The distinct execution permission may require manual approval for certain workflow automations.

With continued reference to FIG. 9, at step 940, the method 900 may include generating a deployment package. The deployment package may be generated based on the component set and the security policy. The deployment package may include configuration data associating the domain-specific agent with the selected analytics application, document index, and workflow automation. The deployment package may include the security policy defining access controls for each component.

At step 950, the method 900 may include causing the domain-specific agent to be available to the user groups via the analytics platform. The causing the domain-specific agent to be available may be based on the deployment package. In some cases, causing the domain-specific agent to be available may comprise publishing the domain-specific agent to a private catalog of the analytics platform based on the deployment package. The private catalog may be visible only to the user groups. The domain-specific agent may be registered in an agent registry accessible to the user groups.

In some cases, the method 900 may further comprise generating an audit log record based on the deployment package. The audit log record may detail the selection of the component set and the security policy. The method 900 may further comprise storing the audit log record in a compliance database. The audit log record may include a timestamp, a user identifier, an assistant identifier, a component accessed, an action performed, a result, an IP address, and a session ID. All permission checks and data access may be logged for audit compliance. Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising
receiving, via a configuration interface of an assistant platform, a first selection of a knowledge base, a second selection of an analytics application, and a third selection of an automation workflow;
based on the first selection, the second selection, and the third selection, generating a custom agent configuration associated with the knowledge base, the analytics application, and the automation workflow;
determining, based on the custom agent configuration, a capability descriptor for a custom agent derived from the custom agent configuration, wherein the capability descriptor specifies query types processable by the custom agent; and
causing, based on the custom agent configuration, the custom agent to be registered in an agent registry, wherein the agent registry is accessible to users of the assistant platform.

2. The method of claim 1, wherein the knowledge base comprises unstructured documents indexed in a vector database, and wherein the capability descriptor indicates that the custom agent can answer queries requiring semantic search of the unstructured documents within the vector database.

3. The method of claim 1, wherein the analytics application is associated with a data model comprising dimensions and metrics, and wherein the capability descriptor indicates that the custom agent can answer queries requiring evaluation of the dimensions and the metrics within the data model.

4. The method of claim 1, wherein the automation workflow is configured to perform an action in an external system, and wherein the capability descriptor indicates that the custom agent can trigger the action in the external system.

5. The method of claim 1, further comprising receiving, via the configuration interface, a permission specification for the custom agent, wherein the permission specification restricts access to the custom agent based on a set of user roles, and wherein the set of user roles defines authorized interactions.

6. The method of claim 5, wherein the permission specification defines a first access level that permits querying the knowledge base and a second access level that permits triggering the automation workflow, and wherein the first access level and the second access level are assigned to distinct user groups identified by the set of user roles.

7. The method of claim 1, wherein the first selection comprises selecting multiple knowledge bases from the plurality of available knowledge bases, and wherein the custom agent configuration links the custom agent configuration to the multiple knowledge bases.

8. A method comprising
receiving, via a configuration tool of an assistant platform, a definition of a specialized assistant, wherein the definition identifies a structured data source and an unstructured data source;
generating, based on the definition, a routing profile for the specialized assistant, wherein the routing profile maps a first set of intents to the structured data source and a second set of intents to the unstructured data source, and wherein the first set of intents and the second set of intents are distinct;
determining, based on the routing profile, a scope of operations for the specialized assistant; and
causing, based on the scope of operations, the specialized assistant to be active in a runtime environment of the assistant platform, wherein the runtime environment executes the specialized assistant.

9. The method of claim 8, wherein the structured data source comprises an associative data model comprising defined fields, and wherein the routing profile maps the first set of intents to the defined fields of the associative data model.

10. The method of claim 8, wherein the unstructured data source comprises a document collection, and wherein the routing profile maps the second set of intents to a semantic search process over the document collection, wherein the semantic search process retrieves content from the document collection.

11. The method of claim 8, wherein the definition further identifies an external action script, and wherein the generating the routing profile comprises mapping, based on the external action script, a third set of intents to the external action script.

12. The method of claim 8, wherein receiving the definition comprises receiving, based on a user input, an update to the definition that adds a new data source, and wherein the method further comprises updating, based on the new data source, the routing profile.

13. The method of claim 8, wherein generating the routing profile comprises resolving, based on a priority rule, an overlap between the first set of intents and the second set of intents, wherein the priority rule defines precedence between the structured data source and the unstructured data source.

14. The method of claim 8, wherein causing the specialized assistant to be active comprises deploying, based on the routing profile, the specialized assistant to a cloud tenant associated with the configuration tool, wherein the cloud tenant hosts the specialized assistant.

15. A method comprising
receiving, via an administration panel of an analytics platform, a request to create a domain-specific agent;
receiving, based on the request, a selection of a component set for the domain-specific agent, wherein the component set comprises an analytics application and a document index;
generating, based on the selection, a security policy for the domain-specific agent, wherein the security policy defines user groups authorized to access the analytics application and the document index through the domain-specific agent;
generating, based on the component set and the security policy, a deployment package; and
causing, based on the deployment package, the domain-specific agent to be available to the user groups via the analytics platform.

16. The method of claim 15, wherein the analytics application is governed by a first access control list, and wherein the generating the security policy comprises inheriting, based on the first access control list, permission rules for the domain-specific agent, wherein the permission rules determine access rights.

17. The method of claim 15, wherein the security policy restricts access to the document index based on a user attribute associated with the user groups, wherein the user attribute indicates a clearance level or a user role.

18. The method of claim 15, wherein the component set further comprises a workflow automation, and wherein the security policy includes a distinct execution permission for the workflow automation, wherein the distinct execution permission authorizes initiation of the workflow automation.

19. The method of claim 15, wherein causing the domain-specific agent to be available comprises publishing, based on the deployment package, the domain-specific agent to a private catalog of the analytics platform, wherein the private catalog is visible only to the user groups.

20. The method of claim 15, further comprising generating, based on the deployment package, an audit log record detailing the selection of the component set and the security policy, and storing the audit log record in a compliance database.
